(19) United States
(12) Patent Application Publication
(10) Pub. No.: US 2026/0025406 A1
(43) Pub. Date: Jan. 22, 2026

(54) System and method for improving network security using machine learning based-threat mitigation

(71) Applicant: Bank of America Corporation, Charlotte, NC (US)

(72) Inventors: Michael R. Young, Davidson, NC (US); Manu Kurian, Dallas, TX (US)

(21) Appl. No.: 18/779,683

(22) Filed: Jul. 22, 2024

(51) Int. Cl. H04L 9/40

(52) U.S. Cl. CPC H04L 63/1441; H04L 63/0236; H04L 63/1425

(57) ABSTRACT

A system for improving network security using machine learning-based threat mitigation is disclosed. The system accesses a data packet that is intended to be communicated to a destination device. The system extracts a first set of network features from the data packet and determines a network path associated with the data packet based on the extracted first set of network features. The system determines, using a machine learning algorithm, based on a training dataset and the extracted first set of network features, that the first destination device is anomalous. In response, the system performs one or more countermeasure actions comprising preventing the data packet from traversing to the first destination device in the network.

### TECHNICAL FIELD

The present disclosure relates generally to network security, and more specifically to a system and method for improving network security using machine learning based-threat mitigation.

### BACKGROUND

Data packets are communicated among devices through a network. Firewall protocols and rules are implemented to protect data stored in devices from unauthorized access.

### SUMMARY

The disclosed system, described in the present disclosure, is particularly integrated into a practical application of improving network security technology. This practical application provides several technical advantages, including dynamically adapting to new and emerging network security threats more effectively than static firewall policies, and detecting and mitigating the emerging network security threats.

In current network security systems, firewall policies and rules are used to catch known security threats. However, the firewall policies and rules are implemented after the damage/effect of a security thread on computing devices. There is a significant delay between the identification of new threats and the subsequent update of firewall rules to mitigate these threats. As a result of this delay, bad actors may have ample time to access and exfiltrate data.

The disclosed system provides a technical solution to these and other technical problems in the realm of network security. The disclosed system proactively monitors network traffic in a network and detects whether a destination device (to which a data packet is intended to be communicated) is compromised. In this process, the disclosed system may evaluate the network path of the data packet using historical data communications as a part of a training dataset of the machine learning algorithm. For example, the disclosed system (e.g., via the machine learning algorithm) may extract a set of network features from the data packet and compare the extracted network features with network features associated with a historical data communication that is labeled with an anomalous indication within the training dataset. If the extracted network features (associated with the data packet) correspond to the network features (associated with the historical data communication), the disclosed system may determine that the destination device is anomalous (e.g., compromised). Once it is determined that the destination device is compromised, the disclosed system implements security protocols to prevent the data packet along the data path to the destination device and/or isolate the destination device from further communications to and from other devices.

The disclosed system further improves network security techniques by proactively detecting malicious data requests and denying malicious data requests. For example, the disclosed system analyzes incoming data requests against known patterns of malicious data requests (included in the historical data communications) as a part of a training dataset of the machine learning algorithm. If network features associated with a data request correspond to network features associated with a known malicious data request (e.g., a historical data communication), the disclosed system denies the data request.

In some embodiments, the disclosed system improves the network security technique by proactively detecting and mitigating cyber threats that attempt to disguise malicious activities within legitimate network traffic, e.g., via protocol tunneling. For example, the disclosed system (e.g., via the machine learning algorithm) may detect that a data request is a Structured Query Language (SQL) query that encapsulates (and obfuscates) a Domain Name System (DNS) traffic in an attempt to redirect a data packet to another domain. In response, the disclosed system may determine that the protocol tunneling is used to obfuscate malicious network traffic because the SQL query that is usually used for safe network requests is used to obfuscate the DNS traffic that is attempting to divert the data packet from its intended and designated domain to another domain. Thus, the disclosed system may deny the data request. The disclosed system may populate the training dataset with instances of malicious data requests and compromised destination devices to refine its detection algorithms and improve its predictive process.

Thus, the disclosed system provides technical solutions to certain technical problems of using firewalls by leveraging the dynamic capabilities of the machine learning algorithm to adapt to new and emerging network security threats more effectively than static firewall policies and detect and mitigate emerging network security threats. Firewalls operate based on predetermined policies that may not catch new or sophisticated cyberattacks that deviate from recognized threat patterns. In contrast, the disclosed system is configured to learn from ongoing network activities and updates its machine learning algorithm and training dataset to identify anomalies and emerging threats that would not necessarily trigger traditional firewall policies.

In this manner, the disclosed system improves the accuracy of cyber threat detections and mitigations, especially against emerging new cyberattack techniques and patterns. The disclosed system, in an ongoing process of learning from new cyberattacks, provides more accurate and up-to-date threat detection compared to the current systems, which improves the efficiency of the threat detection systems.

In some embodiments, a system for improving network security using machine learning-based threat mitigation comprises a memory operably coupled with a processor. The memory is configured to store a training dataset that comprises a set of historical data communications, wherein each of the set of historical data communications is associated with an indication of an anomalous or a safe network path. The processor is configured to access a data packet that is intended to be communicated to a first destination device in a network. The processor is further configured to extract a first set of network features from the data packet, wherein the first set of network features comprises at least one of content, a type of request, an Internet Protocol (IP) address of a source device, or an IP address of the first destination device. The processor is further configured to determine a network path associated with the data packet based at least in part upon the extracted first set of network features. The processor is further configured to determine, using a machine learning algorithm, based at least in part upon the training dataset and the extracted first set of network features, that the first destination device is anomalous. The processor is further configured to perform one or more countermeasure actions in response to determining that the first destination device is anomalous. The one or more countermeasure actions comprise preventing the data packet from traversing to the first destination device in the network.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for improving network security using machine learning based-threat mitigation; and

FIG. 2 illustrates an example flowchart of a method of the system of FIG. 1 for improving network security using machine learning based-threat mitigation.

### DETAILED DESCRIPTION

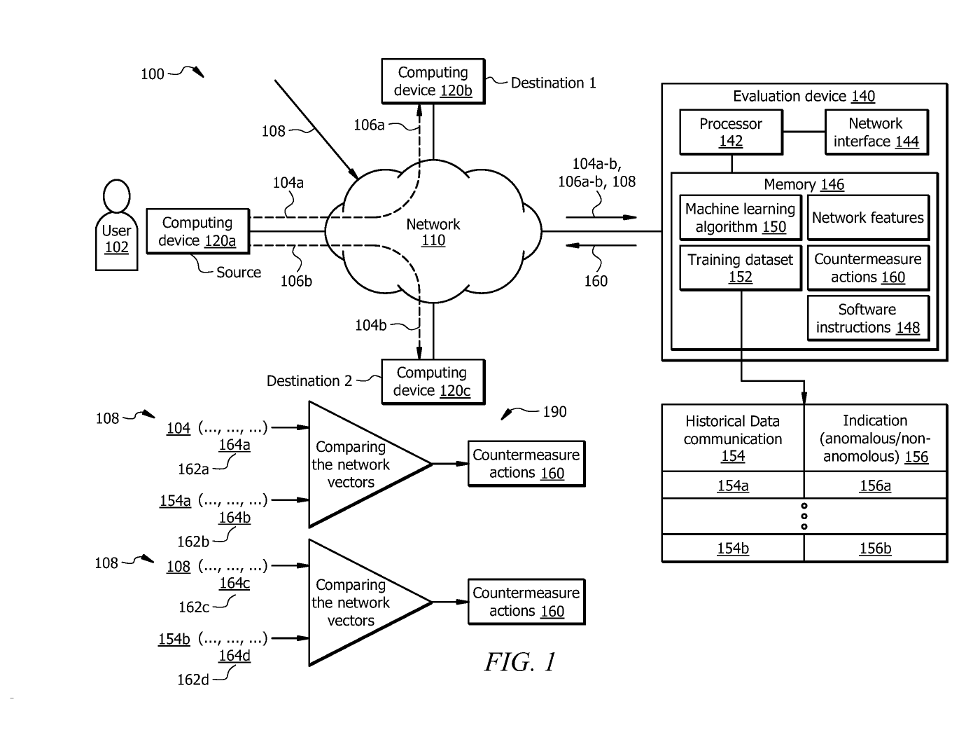

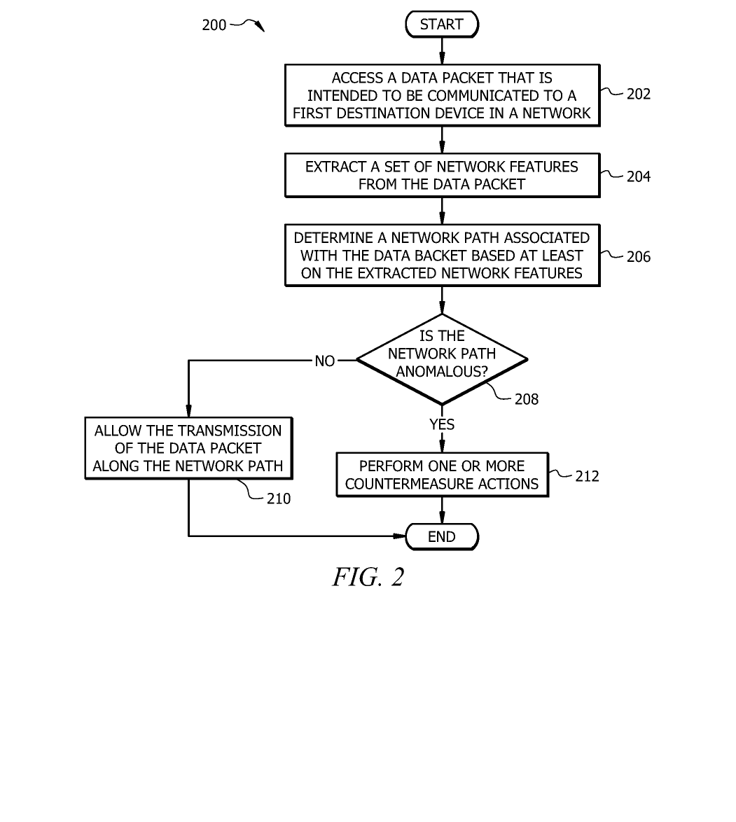

As described above, previous technologies fail to provide efficient and reliable solutions for improving network security using machine learning based-threat mitigation. Embodiments of the present disclosure and its advantages may be understood by referring to FIGS. 1 through 2. FIGS. 1 through 2 are used to describe systems and methods for improving network security using machine learning based-threat mitigation, according to some embodiments.

### System overview

FIG. 1 illustrates an embodiment of a system 100 that is generally configured to implement machine learning algorithms to detect secure network paths, secure computing devices, anomalous network paths (e.g., compromised network paths), and anomalous computing devices (e.g., compromised destination devices). In response to detecting a secure network path or secure computing device, the system 100 is configured to allow data to traverse along the secure network path to the secure destination device. In response to detecting a compromised network path or compromised destination device, the system 100 is configured to block the data from traversing along the compromised network path and/or to the compromised destination device. In some embodiments, the system 100 comprises one or more computing devices 120a-c communicatively coupled with an evaluation device 140 via a network 110. Network 110 enables communication among the components of the system 100. Users may use computing devices 120a-c to communicate data and/or request data from other users. The evaluation device 140 is configured to monitor the data communications among the computing devices 120a-c (including data requests, and other network traffic) via the network 110 and determine whether a network path 106 of a given data packet 104a is anomalous, e.g., whether the network path 106, a data request 108, or a destination device 120b-c (also referred to herein as computing device 12b-c, respectively) is anomalous/compromised by a bad actor to gain unauthorized access to the data packet 104a. The evaluation device 140 is configured to perform mitigation countermeasure actions 160 to address the anomalous network path 106a, malicious data request 108, and compromised destination device 120b. In other embodiments, system 100 may include other elements instead of, or in addition to, those listed above.

In general, the system 100 improves the network security by proactively detecting that a destination device 120b is compromised (e.g., by a bad actor) based on evaluating the network path 106a of the data packet 104a based on historical data communications 154 as a part of a training dataset 152 of the machine learning algorithm 150. For example, the system 100 (e.g., via the machine learning algorithm 150) may extract a set of network features 162a from the data packet 104a and compare the extracted network features 162a with network features 162b associated with a historical data communication 154a that is labeled with an anomalous indication 156a within the training dataset 152. If the extracted network features 162a correspond to the network features 162b of the historical data communication 154a, the system 100 may determine that the destination device 120b is anomalous (e.g., compromised). Once it is determined that the destination device 120b is compromised, the system 100 implements security protocols to prevent the data packet 104a along the network path 106a to the destination device 120b and/or isolate the destination device 102b from further communications to and from other devices.

The system 100 further improves the network security by proactively detecting malicious data requests (e.g., malicious data request 108) and denying the malicious data requests. For example, the system 100 analyzes incoming data requests 108 against known patterns of malicious data requests (included in the historical data communications 154) as a part of a training dataset 152 of the machine learning algorithm 150. If network features 162c associated with a data request 108 correspond to network features 162d associated with a known malicious data request (e.g., historical data communication 154b), the system 100 denies the data request 108.

In some embodiments, the system 100 improves the network security by proactively detecting and mitigating cyber threats that attempt to disguise malicious activities within legitimate network traffic, e.g., via protocol tunneling. For example, the system 100 (e.g., via the machine learning algorithm 150) may detect that a data request 108 is a Structured Query Language (SQL) query that encapsulates (obfuscates) a Domain Name System (DNS) traffic in an attempt to redirect a data packet 104a to another domain. In response, the system 100 may deny the data request 108. The system 100 may populate the training dataset 152 with instances of malicious data requests 108 and compromised destination devices 120b to refine its detection algorithms and improve its predictive process.

Using the system 100 provides technical solutions to certain technical problems of using firewalls by leveraging the dynamic capabilities of the machine learning algorithm 150 to adapt to new and emerging network security threats more effectively than static firewall policies and detect and mitigate the emerging network security threats. Firewalls operate based on predetermined policies that may not catch new or sophisticated cyberattacks that deviate from recognized patterns. In contrast, the machine learning-based threat mitigation system 100 is configured to learn from ongoing network activity and updates its machine learning algorithm 150 and training dataset 152 to identify anomalies and emerging threats that would not necessarily trigger traditional firewall policies.

In this manner, the system 100 improves the accuracy of cyber threat detections and mitigations, especially against emerging new cyberattack techniques and patterns. The system 100, in an ongoing process of learning from new cyberattacks, provides a more accurate and up-to-date threat detection, which improves the efficiency of the threat detection systems.

### SYSTEM COMPONENTS

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may be configured to support any suitable type of communication protocol, as would be appreciated by one of ordinary skills in the art.

### Example computing device

Each of the computing devices 120a, computing device 120b (e.g., first destination device), and computing device 120c (e.g., second destination device) is an instance of a computing device 120. The computing device 120 may generally be any device that is configured to process data and interact with users 102. Examples of the computing device 120 include but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by user 102.

The computing device 120 may include a hardware processor, memory, and/or circuitry configured to perform any of the functions or actions of the computing device 120 described herein. For example, the computing device 120 includes a processor in signal communication with a network interface and a memory. The memory stores software instructions (e.g., code) that, when executed by the processor, cause the processor to perform one or more operations of the computing device 120 described herein. The user 102 may use the computing device 120a to initiate the communication of the data packet 104a to other devices 120. The data packet 104a may include any data, including files, documents, code, and the like.

### Evaluation device

The evaluation device 140 may include one or more hardware computer systems, such as workstations, virtual machines, etc. For example, the evaluation device 140 may be implemented by a plurality of computing devices using distributed computing and/or cloud computing systems in a network. In some embodiments, the evaluation device 140 may be one or more servers in a server farm. In some embodiments, the evaluation device 140 may include one or more servers in one or more data centers, data warehouses, and the like. The evaluation device 140 may be an instance of one or more servers. In certain embodiments, the evaluation device 140 may be configured to provide services and resources (e.g., data and/or hardware resources) to the components of the system 100. The evaluation device 140 (e.g., via the machine learning algorithm 150) may evaluate each network path 106a-b of data and determine whether the network path 106a-b leads to a compromised destination device 120b-c. In response, the evaluation device 140 may block a network path 106 to the compromised destination device 120b. Similarly, the evaluation device 140 (e.g., via the machine learning algorithm 150) may evaluate each data request 108 and determine whether the data request 108 is malicious. In response, the evaluation device 140 may deny the data request 108.

The evaluation device 140 comprises a processor 142 operably coupled with a network interface 144 and a memory 146. Processor 142 comprises one or more processors. The processor 142 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and stores the results of ALU operations. The processor 142 may further include a control unit that fetches instructions from memory and executes them by directing the coordinated operations of the ALU, registers and other components. The one or more processors are configured to implement various software instructions. For example, the one or more processors are configured to execute instructions (e.g., software instructions 148) to perform the operations of the evaluation device 140 described herein. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-2. For example, the processor 142 may be configured to perform one or more operations of the operational flow 190 described in FIG. 1, and one or more operations of the method 200 as described in FIG. 2.

Network interface 144 is configured to enable wired and/or wireless communications. The network interface 144 may be configured to communicate data between the evaluation device 140 and other devices, systems, or domains of the system 100. For example, the network interface 144 may comprise a near-field communication (NFC) interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise read-only memory (ROM), random-access memory (RAM), ternary content-addressable memory (TCAM), dynamic random-access memory (DRAM), and static random-access memory (SRAM). The memory 146 may include one or more of a local database, cloud database, network-attached storage (NAS), etc. The memory 146 comprises one or more disks, tape drives, or solid-state drives, and may be used as an over-flow data storage device, to store programs when such programs are selected for execution, and to store instructions and data that are read during program execution. The memory 146 may store any of the information described in FIGS. 1-2 along with any other data, instructions, logic, rules, or code operable to implement the function(s) described herein when executed by processor 142. For example, the memory 146 may store software instructions 148, machine learning algorithm 150, training dataset 152, network features 162a-d, network vectors 164a-d, countermeasure actions 160, and/or any other data or instructions. The software instructions 148 may comprise any suitable set of instructions, logic, rules, or code operable to execute the processor 142 and perform the functions described herein, such as some or all of those described in FIGS. 1-2.

The machine learning algorithm 150 may be implemented by the processor 142 executing the software instructions 148 and is generally configured to detect and mitigate potential security threats associated with compromised devices 120 and malicious data requests 108. The machine learning algorithm 150 may comprise a support vector machine, neural network, random forest, k-means clustering, etc. The machine learning algorithm 150 may be implemented by a plurality of neural network (NN) layers, convolutional NN (CNN) layers, long-short-term-memory (LSTM) layers, Bi-directional LSTM layers, recurrent NN (RNN) layers, and the like. In some examples, the machine learning algorithm 150 may be implemented by natural language processing (NLP), data processing, text recognition, generative text processing, programming code processing, programming code generation, etc.

In some embodiments, the machine learning algorithm 150 may perform code segmentation, network traffic segmentation, word segmentation, sentence segmentation, word tokenization, sentence tokenization, and analysis on a given data (e.g., data packet 104a, data request 108, data communication 154, etc.) to detect patterns of network features associated with known compromised devices and/or known malicious requests. The network features associated with known compromised devices and/or known malicious requests may include signatures of malware, indications of documented malware, unusual data flows, anomalous access patterns, irregularities in the frequencies or sizes of data packets compared to previously authorized network activities, deviations from previously authorized network activities, which suggest spoofing, unusual protocol tunneling, among others. The machine learning algorithm 150 may use the detected network features to automatically classify and flag (e.g., fingerprint) different network traffic (i.e., network paths 106, data requests 108), destination devices 120, and/or source devices 120 as potentially malicious or secure. Such operations are described in greater detail further below in conjunction with the operational flow 190 of the system 100.

The machine learning algorithm 150 may populate and be trained with the training dataset 152. The training dataset 152 comprises a set of historical data communications 154, where each of the historical data communications 154 is associated with a respective indication 156 of anomalous or a safe/secure network path. For example, the first historical data communication 154a may be associated with an anomalous indication 156a, and the second historical data communication 154b may be associated with a secure network path. In some embodiments, a network path 106 may be determined to be safe and secure if the devices 120 along the network path 106 and/or at the end of the network path 106 are determined to be anomalous (e.g., compromised by a bad actor to gain unauthorized access to the data packet carried along the network path 106). In some examples, a historical data communication 154 may include and/or be associated with a historical data request 108 to access a data packet 104a. For example, if the data request 108 is a SQL query that is encapsulating a DNS traffic, the machine learning algorithm 150 may determine that the data request 108 is malicious because the SQL query that is usually used for safe network requests is used to obfuscate the DNS traffic that is attempting to divert the data packet from its intended and designated domain to another, malicious domain. In response, the machine learning algorithm 150 may predict that the data request 108 is malicious, label or flag it as a malicious request, and store it in the training dataset 152. Further in response, the evaluation device 140 may perform one or more countermeasure actions 160 to address the data request 108. The machine learning algorithm 150 may use this information for predicting whether future data requests are malicious, and if it is determined that a data request is malicious, perform one or more countermeasure actions 160.

The evaluation device 140 may populate the training dataset 152 with the ongoing predictions of network traffic as anomalous. The prediction of the machine learning algorithm 150 may be overridden, updated, or confirmed by network administrators to implement supervised machine learning to improve the accuracy of the predictions of the machine learning algorithm 150.

### Example operational flow for evaluating a network path and mitigating a security threat

The example operational flow 190 of the system 100 for evaluating a network path 106 (e.g., any of network paths 106a-b) is described below. In operation, the operational flow 190 may begin when the evaluation device 140 accesses a data packet 104 (e.g., any of data packets 104a-b). For example, the evaluation device 140 may receive or access the data packets 104 communicated among internal computing devices 120a-c associated with an organization and external computing devices 120 with respect to the organization.

The evaluation device 140 may act as a gateway that is configured to access and evaluate the data packets 104 communicated via the network 110. The evaluation device 140 may access the data packet 104a that originated from the source computing device 120a and is intended to be communicated to the destination device 120b. The data packet 104a may include one or more headers that indicate the network path 106a of the data packet 104a. For example, the headers of the data packet 104a may include information such as the source and destination Internet Protocol (IP) addresses, IP addresses of network devices (e.g., routers, switches, etc.) along the network path 106a, protocol type, and other relevant metadata that informs routing decisions of the data packet 104a along one or more routers and/or switches.

### Evaluating whether the network path of the data packet is anomalous

The evaluation device 140 may feed the data packet 104a to the machine learning algorithm 150 for evaluation. The machine learning algorithm 150 may extract a set of network features 162a from the data packet 104a, where the network features 162a may include content, a type of request, an IP address of a source device 120a, an IP address of the first destination device 120b, IP addresses of network devices (e.g., routers, switches, etc.) along the network path 106a, among others. Based on the network features 162a, the machine learning algorithm 150 may determine the network path 106a of the data packet 104a. The network features 162a may be represented by the network feature vector 164a which comprises a set of numerical values that represent the network features 162a. Subsequently, the machine learning algorithm 150 may analyze the network features 162a to determine whether the characteristics of the data packet 104a correspond to patterns previously identified as indicators of compromised security or malicious activity. The patterns previously identified as indicators of compromised security or malicious activity may include signatures of malware, indications of documented malware, unusual data flows, anomalous access patterns, irregularities in the frequencies or sizes of data packets compared to previously authorized network activities, deviations from previously authorized network activities, which suggest spoofing, unusual protocol tunneling, among others.

In this process, the machine learning algorithm 150 may determine whether the destination device 120b is anomalous (e.g., compromised by a bad actor to gain access to the data packet 104a) based on evaluating the network features 162a against the training dataset 152. To this end, the machine learning algorithm 150 may compare the network features 162a associated with the data packet 104a against network features of each entry of the training dataset 152. For example, with respect to a first historical data communication 154a, the machine learning algorithm 150 may extract a set of network features 162b from the first historical data communications 154a, where the network features 162b may include content, a type of request, an IP address of a source device, an IP address of a destination device, IP addresses of network devices (e.g., routers, switches, etc.) along a network path of the first historical data communication 154a, the protocol tunneling (e.g., a SQL query encapsulating a DNS traffic, an HTTP request concealing SSH (Secure Shell) commands, a VoIP (Voice over Internet Protocol) packet transporting FTP commands, etc.), among others. among others. The network features 162b may be represented by the network feature vector 164b which comprises a set of numerical values that represent the network features 162b.

The machine learning algorithm 150 may compare the network vector 164a with the network vector 164b to determine whether they correspond with each other. In some embodiments, if it is determined that more than a threshold percentage (e.g., more than 80%, 85%, etc.) of the network features 162a corresponds to counterpart network features 162b associated with the first historical data communication 154a, the machine learning algorithm 150 may determine that the network path 106a is associated with a same indication 156a to which the historical data communication 154a is associated.

In some embodiments, the machine learning algorithm 150 may determine a distance (e.g., Euclidean distance) between the network vectors 164a and 164b in a vector space. If the determined distance is less than a threshold distance, the machine learning algorithm 150 may determine that the network path 106a is associated with the same indication 156a with which the historical data communication 154a is associated. For example, if the historical data communication 154a is associated with an anomalous indication 156a, the machine learning algorithm 150 may determine that the network path 106a is associated with the anomalous indication 156a. In this example, in response to determining that more than the threshold percentage (e.g., more than 80%, 85%, etc.) of the network features 162a corresponds to counterpart network features 162b associated with the first historical data communication 154a, the machine learning algorithm 150 may determine that the network path 106a is associated with the anomalous indication 156a.

If it is determined that the network vector 164a corresponds to the network vector 164b, the machine learning algorithm 150 may determine that the network path 106a is associated with the same indication 156a to which the historical data communication 154a is associated. Otherwise, the machine learning algorithm 150 may move on to the next entry in the training dataset 152 to evaluate against the data packet 104a and network path 106a.

In this manner, the machine learning algorithm 150 may compare the current data packet 104a’s network features 162a against a database of known threat signatures and anomalous behaviors as indicated by the training dataset 152. If the data packet 104a exhibits suspicious characteristics suggesting a security threat (e.g., malware distribution, data exfiltration attempt), the evaluation device 140 may mitigate this security threat detection by performing one or more countermeasure actions 160.

Alternatively, if the data packet 104a is deemed safe (based on comparing the network features 162a with each of the network features 162 associated with each historical data communication 154a-b), the evaluation device 140 allows the data packet 104a to continue along its intended path 106a to the destination device 120b.

### Mitigating the anomalous network path

The evaluation device 140 may execute/perform one or more countermeasure actions 160 in response to determining that the destination device 120b is anomalous. In some embodiments, the countermeasure actions 160 may include preventing the data packet 104a from traversing to the destination device 120a in the network 110, e.g., via the network path 106a or any other network paths. In some embodiments, the countermeasure actions 160 may include blocking data communications to and from the destination device 120b. In some embodiments, the countermeasure actions 160 may include associating the destination device 120b with an anomalous indication 156 and storing this information along with the data packet 104a in the training dataset 152, as a data communication 154. In some embodiments, the countermeasure actions 160 may include implementing a firewall policy to block communications associated with the IP address associated with the destination device 120b. In some embodiments, the countermeasure actions 160 may include logging data requests, data usage, and other activities associated with the destination device 120b, e.g., for forensic investigations.

### Evaluating a data request to access the data packet

In some cases, a data request 108 may be received, where the data request 105 may indicate to provide access to the data packet 104a. The data request 108 may be sent to the source computing device 120a where the transfer of data packet 104a originated or any other device along the network path 160a of the data packet 104a. For example, the data request 108 may be initiated from an unknown device whose IP address is not among the authorized IP addresses. The evaluation device 140 may intercept and access the data request 108 and evaluate it to determine whether it is malicious.

To this end, the machine learning algorithm 150 may perform similar operations to compare the network characteristics of the data request 108 with the known anomalous network characteristics as indicated in the training dataset 152. For example, the machine learning algorithm 150 may extract a set of network features 162c from the data request 108, where the network features 162c may include content, a type of request (e.g., what is requested in the data request 108), an IP address associated with the data request 108, a type of network traffic used for the data request 108 (e.g., SQL query, Hypertext Transfer Protocol (HTTP) request, File Transfer Protocol (FTP) command, Representational State Transfer (REST) API call, Simple Object Access Protocol (SOAP) request), a protocol tunneling associated with the data request 108, among others. The network features 162c may be represented by network vector 164c which comprises a set of numerical values.

Based on the network features 162c and the training dataset 152, the machine learning algorithm 150 may determine the type of the network traffic and its structure. For example, assume that the machine learning algorithm 150 determines that the data request 108 is a SQL query that encapsulates a DNS traffic. In this example, the machine learning algorithm 150 may determine that the SQL query is used to obfuscate the DNS traffic to redirect the data packet 104a to another domain. In this process, the machine learning algorithm 150 may compare the network features 162c with network features 162 of each entry in the training dataset 152. With respect to the historical data communication 154b, the machine learning algorithm 150 may extract the network features 162d, where the network features 162d include content, a type of request, an IP address of a source device, an IP address of a destination device, IP addresses of network devices (e.g., routers, switches, etc.) along a network path of the first historical data communication 15b, the protocol tunneling (e.g., a SQL query encapsulating a DNS traffic, an HTTP request concealing SSH (Secure Shell) commands, a VoIP (Voice over Internet Protocol) packet transporting FTP commands, etc.), among others. In this example, assume that the historical data communication 154b is an SQL query encapsulating a DNS traffic. Some protocol tunneling (including some or all of those listed herein) may be used by bad actors to obfuscate their true intentions and activities by masking a malicious code, script, or data in a network layer under a seemingly legitimate data request to evade detection by traditional firewalls and security measures. The network features 162d may be represented by the network vector 164d which comprises a set of numerical values.

The machine learning algorithm 150 may use the protocol tunneling as indicated in the network features 162a to identify, classify, and respond to such malicious data requests 108. By analyzing patterns and discrepancies in the encapsulated data, the machine learning algorithm 150 may flag suspicious activities and implement security protocols to mitigate potential threats associated with the data requests 108. Other protocol tunneling may be determined to be safe in response to validation against a list of recognized and approved protocol tunneling and protocols.

The machine learning algorithm 150 may compare the network vector 164c with the network vector 164d to determine whether they correspond to each other. In some embodiments, if it is determined that more than a threshold percentage (e.g., more than 80%, 85%, etc.) of the network features 162c correspond to the counterpart network features 162d, the machine learning algorithm 150 may determine that the network vectors 164c and 164d correspond to each other. In some embodiments, the machine learning algorithm 150 may determine a distance (e.g., Euclidean distance) between the network vectors 164c and 164d in the vector space. If it is determined that the distance between the network vectors 164c and 164d is less than a threshold distance (e.g., less than 0.1, 0.2, etc.), the machine learning algorithm 150 may determine that the data request 108 is associated with the same indication 156b to which the historical data communication 154b is associated. For example, based on the comparison between the network features 162c and 162d, the machine learning algorithm 150 may determine that the data request 108 is a SQL query that encapsulates a DNS traffic. This protocol tunneling may be historically known to be used by bad actors to mask and obfuscate malicious traffic or operations. This information may be indicated in the entry of the historical data communication 154b in conjunction with the anomalous indication 156b.

In some embodiments, if it is determined that more than a threshold percentage (e.g., more than 80%, 85%, etc.) of the network features 162c correspond to the counterpart network features 162d, the machine learning algorithm 150 may determine the data request 108 is a SQL query that is encapsulating a DNS traffic. In response, the machine learning algorithm 150 may determine that the SQL query is used to obfuscate the DNS traffic to redirect the data packet 104a to another, unknown, malicious domain. Further in response, the evaluation device 140 may deny the data request 108. Otherwise, the evaluation device 140 may evaluate the data request 108 against the next entry in the training dataset 152 until no entry is left for evaluation.

The evaluation device 140 may grant the data request 108 if it is determined to be safe, e.g., in response to determining that the data request 108 corresponds to a historical data communication 154 that is associated with a safe indication 156.

In some embodiments, the evaluation device 140 may update the training dataset 152 to include network path 106a to the destination device 120b associated with an anomalous indication 156. In some embodiments, the evaluation device 140 may utilize quantum entanglement principles to reposition the data packet to a secure location or network path when the destination device 120b is determined to be anomalous.

The evaluation device 140 may allow the data packet 104b to travel to the destination device 120c along the network path 106b if it is determined that the network path 106b and destination device 120c are safe and not compromised.

### Method for improving network security using machine learning based-threat mitigation

FIG. 2 illustrates an example flowchart of a method 200 for improving network security using machine learning based-threat mitigation, according to some embodiments. Modifications, additions, or omissions may be made to method 200. Method 200 may include more, fewer, or other operations. For example, operations may be performed in parallel or in any suitable order. While at times, it is discussed that the system 100, evaluation device 140, or components of any thereof perform some operations, any suitable system or components of the system may perform one or more operations of the method 200. For example, one or more operations of method 200 may be implemented, at least in part, in the form of software instructions 148 of FIG. 1, stored on a tangible non-transitory machine-readable medium (e.g., memory 146 of FIG. 1) that, when run by one or more processors (e.g., processor 142 of FIG. 1), may cause the one or more processors to perform operations 202-212.

At operation 202, the evaluation device 140 may access a data packet 104a that is intended to be communicated to a first destination device 120b in a network 110, similar to that described in FIG. 1. At operation 204, the evaluation device 140 may extract a set of network features 162a from the data packet 104a. For example, the evaluation device 140 may feed the data packet 104a to the machine learning algorithm 150 to extract the network features 162a.

At operation 206, the evaluation device 140 determines a network path 106a associated with the data packet 104a based on the extracted network features 162a. For example, the network path 106a may include identifiers (e.g., IP addresses) of various network components such as routers, switches, gateways, and firewalls through which the data packet travels from the source computing device 120a to the destination device 120b.

At operation 208, the evaluation device 140 determines whether the network path 106a is anomalous. For example, the evaluation device 140 may compare the network features 162a with network features 162b of each historical data communication 154a included in the training dataset 152, similar to that described in FIG. 1. If it is determined that the network path 106a is anomalous, the method 200 proceeds to operation 212. Otherwise, the method 200 proceeds to operation 210. In some embodiments, the evaluation device 140 may evaluate the network path 106a at multiple stages along the network path 106a, e.g., before the data packet 104a reaches each network component (e.g., switch, router, etc.), network node (e.g., base station, etc.) along the network path 106a. At operation 210, the evaluation device 140 allows the transmission of the data packet 104 along the network path 106a. At operation 212, the evaluation device 140 performs one or more countermeasure actions 160, similar to that described in FIG. 1.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory configured to store a training dataset that comprises a set of historical data communications, wherein each of the set of historical data communications is associated with an indication of an anomalous or a safe network path; and
a processor, operably coupled to the memory, and configured to:
access a data packet that is intended to be communicated to a first destination device in a network;
extract a first set of network features from the data packet, wherein the first set of network features comprises at least one of content, a type of request, an Internet Protocol (IP) address of a source device, or an IP address of the first destination device;
determine a network path associated with the data packet based at least in part upon the extracted first set of network features;
determine, using a machine learning algorithm, based at least in part upon the training dataset and the extracted first set of network features, that the first destination device is anomalous; and
in response to determining that the first destination device is anomalous, perform one or more countermeasure actions, wherein the one or more countermeasure actions comprise preventing the data packet from traversing to the first destination device in the network.

2. The system of claim 1, wherein determining, based at least in part upon the training dataset and the extracted first set of network features, that the first destination device is anomalous comprises:
comparing each of the extracted first set of network features with a counterpart network feature associated with a first historical data communication from the training dataset, wherein the first historical data communication is associated with an anomalous indication;
determining that more than a threshold percentage of the extracted first set of network features corresponds to counterpart network features associated with the first historical data communication; and
in response to determining that more than the threshold percentage of the extracted first set of network features corresponds to counterpart network features associated with the first historical data communication, determining that the network path is associated with the anomalous indication.

3. The system of claim 1, wherein the processor is further configured to block data communications to and from the first destination device.

4. The system of claim 1, wherein the one or more countermeasure actions further comprise at least one of the following:
associating the first destination device with an anomalous indication;
implementing a firewall policy to block communications associated with the IP address associated with the first destination device; or
logging data requests and data usage associated with the first destination device.

5. The system of claim 1, wherein the processor is further configured to:
detect a data request to access the data packet;
extract a second set of network features from the data request, wherein the second set of network features comprises a type of request, the IP address associated with the data request, or a type of network traffic;
determine, based at least in part upon the extracted second set of network features and the training dataset, that the data request is a Structured Query Language (SQL) query encapsulating a Domain Network System (DNS) traffic;
determine that the SQL query is used to obfuscate the DNS traffic to redirect the data packet to another domain; and
in response to determining that the SQL query is used to obfuscate the DNS traffic to redirect the data packet to another domain, deny the data request.

6. The system of claim 5, wherein determining, based at least in part upon the extracted second set of network features and the training dataset, that the data request is the SQL query encapsulating a DNS traffic, comprises:
comparing each of the extracted second set of network features with a counterpart network feature associated with a second historical data communication from the training dataset, wherein the second historical data communication is an SQL query encapsulating a DNS traffic;
determining that more than a threshold percentage of the extracted second set of network features corresponds to counterpart network features associated with the second historical data communication; and
in response to determining that more than the threshold percentage of the extracted second set of network features corresponds to counterpart network features associated with the second historical data communication, determining that the data request is the SQL query encapsulating the DNS traffic.

7. The system of claim 1, wherein the processor is further configured to update the training dataset to include the network path to the first destination device associated with an anomalous indication.

8. A method comprising:
accessing a data packet that is intended to be communicated to a first destination device in a network;
extracting a first set of network features from the data packet, wherein the first set of network features comprises at least one of content, a type of request, an Internet Protocol (IP) address of a source device, or an IP address of the first destination device;
determining a network path associated with the data packet based at least in part upon the extracted first set of network features;
determining, using a machine learning algorithm, based at least in part upon a training dataset and the extracted first set of network features, that the first destination device is anomalous, wherein the training dataset comprises a set of historical data communications, wherein each of the set of historical data communications is associated with an indication of an anomalous or a safe network path; and
in response to determining that the first destination device is anomalous, performing one or more countermeasure actions, wherein the one or more countermeasure actions comprise preventing the data packet from traversing to the first destination device in the network.

9. The method of claim 8, wherein determining, based at least in part upon the training dataset and the extracted first set of network features, that the first destination device is anomalous comprises:
comparing each of the extracted first set of network features with a counterpart network feature associated with a first historical data communication from the training dataset, wherein the first historical data communication is associated with an anomalous indication;
determining that more than a threshold percentage of the extracted first set of network features corresponds to counterpart network features associated with the first historical data communication; and
in response to determining that more than the threshold percentage of the extracted first set of network features corresponds to counterpart network features associated with the first historical data communication, determining that the network path is associated with the anomalous indication.

10. The method of claim 8, further comprising blocking data communications to and from the first destination device.

11. The method of claim 8, wherein the one or more countermeasure actions further comprise at least one of the following:
associating the first destination device with an anomalous indication;
implementing a firewall policy to block communications associated with the IP address associated with the first destination device; or
logging data requests and data usage associated with the first destination device.

12. The method of claim 8, further comprising:
detecting a data request to access the data packet;
extracting a second set of network features from the data request, wherein the second set of network features comprises a type of request, the IP address associated with the data request, or a type of network traffic;
determining, based at least in part upon the extracted second set of network features and the training dataset, that the data request is a Structured Query Language (SQL) query encapsulating a Domain Network System (DNS) traffic;
determining that the SQL query is used to obfuscate the DNS traffic to redirect the data packet to another domain; and
in response to determining that the SQL query is used to obfuscate the DNS traffic to redirect the data packet to another domain, denying the data request.

13. The method of claim 12, wherein determining, based at least in part upon the extracted second set of network features and the training dataset, that the data request is the SQL query encapsulating a DNS traffic, comprises:
comparing each of the extracted second set of network features with a counterpart network feature associated with a second historical data communication from the training dataset, wherein the second historical data communication is an SQL query encapsulating a DNS traffic;
determining that more than a threshold percentage of the extracted second set of network features corresponds to counterpart network features associated with the second historical data communication; and
in response to determining that more than the threshold percentage of the extracted second set of network features corresponds to counterpart network features associated with the second historical data communication, determining that the data request is the SQL query encapsulating the DNS traffic.

14. The method of claim 8, further comprising updating the training dataset to include the network path to the first destination device associated with an anomalous indication.

15. A non-transitory computer-readable medium storing instructions that, when executed by a processor, cause the processor to:
access a data packet that is intended to be communicated to a first destination device in a network;
extract a first set of network features from the data packet, wherein the first set of network features comprises at least one of content, a type of request, an Internet Protocol (IP) address of a source device, or an IP address of the first destination device;
determine a network path associated with the data packet based at least in part upon the extracted first set of network features;
determine, using a machine learning algorithm, based at least in part upon a training dataset and the extracted first set of network features, that the first destination device is anomalous, wherein the training dataset comprises a set of historical data communications, wherein each of the set of historical data communications is associated with an indication of an anomalous or a safe network path; and
in response to determining that the first destination device is anomalous, perform one or more countermeasure actions, wherein the one or more countermeasure actions comprise preventing the data packet from traversing to the first destination device in the network.

16. The non-transitory computer-readable medium of claim 15, wherein determining, based at least in part upon the training dataset and the extracted first set of network features, that the first destination device is anomalous comprises:
comparing each of the extracted first set of network features with a counterpart network feature associated with a first historical data communication from the training dataset, wherein the first historical data communication is associated with an anomalous indication;
determining that more than a threshold percentage of the extracted first set of network features corresponds to counterpart network features associated with the first historical data communication; and
in response to determining that more than the threshold percentage of the extracted first set of network features corresponds to counterpart network features associated with the first historical data communication, determining that the network path is associated with the anomalous indication.

17. The non-transitory computer-readable medium of claim 15, wherein the instructions further cause the processor to block data communications to and from the first destination device.

18. The non-transitory computer-readable medium of claim 15, wherein the one or more countermeasure actions further comprise at least one of the following:
associating the first destination device with an anomalous indication;
implementing a firewall policy to block communications associated with the IP address associated with the first destination device; or
logging data requests and data usage associated with the first destination device.

19. The non-transitory computer-readable medium of claim 15, wherein the instructions further cause the processor to:
detect a data request to access the data packet;
extract a second set of network features from the data request, wherein the second set of network features comprises a type of request, the IP address associated with the data request, or a type of network traffic;
determine, based at least in part upon the extracted second set of network features and the training dataset, that the data request is a Structured Query Language (SQL) query encapsulating a Domain Network System (DNS) traffic;
determine that the SQL query is used to obfuscate the DNS traffic to redirect the data packet to another domain; and
in response to determining that the SQL query is used to obfuscate the DNS traffic to redirect the data packet to another domain, deny the data request.

20. The non-transitory computer-readable medium of claim 15, wherein the instructions further cause the processor to utilize quantum entanglement principles to reposition the data packet to a secure location or network path when the first destination device is determined to be anomalous.
